(19) United States
(12) Patent Application Publication
(10) Pub. No.: US 2002/0187404 A1
(43) Pub. Date: Dec. 12, 2002

(54) Liquid electrolyte composition and lithium battery comprising same

(76) Inventors: Kwon-Sun Roh, Cheonan-si (KR); Dong-Joon Ihm, Seoul (KR); Jon-Ha Lee, Cheonan-si (KR)

Correspondence Address: ANDERSON KILL & OLICK, P.C., 1251 Avenue of the Americas, New York, NY, 10020, US

(21) Appl. No.: 10/117,100

(22) Filed: Apr. 5, 2002

(30) Foreign Application Priority Data
May 16, 2001 (KR) 2001-26758

(51) Int. Cl. H01M 10/40

(52) U.S. Cl. 429/325; 429/345; 252/62.2

(57) ABSTRACT

A liquid electrolyte composition comprising a sulfide of a IV-group element, an organic solvent and a lithium salt is advantageously used for the preparation of a lithium battery having improved mean voltage, cycling life and capacity properties.

### FIELD OF THE INVENTION

The present invention relates to a liquid electrolyte composition for use in a lithium battery for providing improved mean voltage, cycling life and self-discharge properties, which comprises a sulfide of a IV-group element, and the lithium battery comprising said electrolyte.

### BACKGROUND OF THE INVENTION

Lithium secondary batteries have a common structural feature that includes a cathode, an anode, an organic electrolyte and a lithium ion-permeable separator disposed between the electrodes. The electrical energy is generated by redox reactions occurring on the electrodes. The lithium secondary batteries have generally two types depending to the kind of electrolyte used: a lithium ion battery employing a liquid electrolyte; and a lithium ion polymer battery using a solid polymer electrolyte.

There have been reported several methods to improve energy density, cycling life and other properties of the lithium battery by incorporating various additives into the electrode or electrolyte. However, when an additive is incorporated into the electrode, the electrode active material content becomes low, resulting in a loss of energy density (see Japanese Publication No. 10-40911). Accordingly, a preferred method has been to incorporate an additive into the liquid electrolyte, with a view to improving the ionic conductivity of the electrolyte without lowering energy density, as disclosed in Japanese Publication Nos. 10-223258 and 6-333598, U.S. Pat. No. 4,618,548 and European Patent No. 1,022,799.

Japanese Publication No. 10-223258 describes a method of adding a boron compound to a liquid electrolyte. The boron compound employed in this method can increase the ionic conductivity of the electrolyte by facilitating the dissociation of lithium salts. Unfortunately, however, it is rather difficult to handle the boron compound under normal working conditions due to its highly reactive property.

Japanese Publication No. 6-333598 and U.S. Pat. No. 4,618,548 provide a method of adding an amine compound to a liquid electrolyte. However, since the cathode's oxidation-reduction voltage becomes about 2V when such amine is added, this method is not suitable for a lithium secondary battery system having a cathode oxidation-reduction voltage of around 4V, e.g., a battery which employs a lithium cobalt oxide (LiCoO₂).

### SUMMARY OF THE INVENTION

Accordingly, it is an object of the present invention to provide a liquid electrolyte composition having improved mean voltage, cycling life and self-discharge properties.

It is another object of the present invention to provide a lithium battery comprising such an electrolyte.

In accordance with one aspect of the present invention, there is provided a liquid electrolyte composition comprising a sulfide of a IV-group element, an organic solvent and a lithium salt.

### BRIEF DESCRIPTION OF THE DRAWINGS

The above and other objects and features of the present invention will become apparent from the following description of the invention, when taken in conjunction with the accompanying drawings, which respectively show:

FIG. 1: variations of regular discharge capacity(%) of the lithium ion batteries obtained in Examples and Comparative Examples as a function of discharge rate(C);

FIG. 2: changes in the voltage(V) at 2C(1300 mA) discharge rate of the lithium ion batteries obtained in Examples and Comparative Examples; and

FIG. 3: variations of regular discharge capacity(%) of the lithium ion batteries obtained in Examples and Comparative Examples as a function of cycling number.

### DETAILED DESCRIPTION OF THE INVENTION

In accordance with the present invention, there is provided an organic electrolytic solution comprising a sulfide of a IV-group element as a quality-enhancing additive in an amount ranging from 0.01 to 0.4% by weight, preferably from 0.05 to 0.3% by weight based on the total weight of the electrolytic solution. When the amount of the disulfide compound is more than 0.4% by weight, the capacity and cycling life properties are decreased and an SEI film resistance is increased.

Among the sulfide of the present invention, preferred is carbon disulfide.

Exemplary lithium salts that may be used in the present invention are LiClO₄, LiBF₄, LiPF₆, LiCF₃SO₃, LiN(CF₃SO₂)₂ and a mixture thereof. The lithium salt may be present in a concentration ranging from 0.5 to 2.0M in the electrolytic solution. When the concentration of the salt is less than 0.5M, the capacity becomes poor; and when more than 2.0M, poor cycling life property results.

Representative examples of the organic solvent used in the present invention include propylene carbonate, ethylene carbonate, diethyl carbonate, dimethyl carbonate, ethylmethyl carbonate, dipropyl carbonate, dimethyl sulfoxide, acetonitrile, dimethoxyethane, diethoxyethane, vinylene carbonate, gamma-butyrolactone, ethylene sulfite, propylene sulfite and tetrahydrofuran.

The inventive electrolytic solution may be prepared by simply mixing the sulfide, the lithium salt and the organic solvent.

In accordance with another aspect of the present invention, there is provided a lithium battery comprising a cathode, an anode, a separator interposed between the cathode and the anode, and said electrolyte composition. The present invention may be applied to any type of lithium batteries.

Typically, a cathode composition, i.e., a mixture of a cathode active material, a conducting agent, a binder and a solvent, may be coated directly on an aluminum current collector, or laminated in the form of a film on an aluminum current collector to form a cathode sheet.

The cathode active material may be lithium-containing metal oxides such as LiCoO₂, LiMnₓO₂ₓ and LiNi₁₋ₓMnₓO₂ₓ (wherein x is 1 or 2). The conducting agent may be carbon black; the binder may be vinylidene fluoride/hexafluoropropylene copolymers, polyvinylidene fluoride, polyacrilonitrile, polymethylmetacrilate or polytetrafluoroethylene; and the solvent may be N-methylpyrrolidone or acetone. The conducting agent, the binder and the solvent may be used in an amount ranging from 1 to 10 parts by weight, from 2 to 10 parts by weight and from 30 to 100 parts by weight based on 100 parts by weight of the cathode active material, respectively.

Also, an anode composition, i.e., a mixture of an anode active material, a conducting agent, a binder and a solvent, may be coated directly on a copper current collector, or laminated in the form of a film on a copper current collector to form an anode sheet.

Representative examples of the anode active material may include lithium metals, lithium alloys, carbon-based materials and graphite. The conducting agent, the binder and the solvent, which may be the same as those used in the cathode composition, may be used in an amount of below 10 parts by weight, ranging from 2 to 10 parts by weight and from 30 to 100 parts by weight based on 100 parts by weight of the anode active material, respectively. If necessary, a plasticizer may be further added to said cathode and anode compositions to form porous electrode sheets.

Further, a separator which is interposed between the cathode and the anode sheets may be of a microporous sheet made from, for example, a polymeric material such as polyethylene and polypropylene.

An appropriate separator sheet is located between the cathode and the anode sheets to form an electrode stack. The electrode stack is wound or folded, placed into a cylindrical or angular battery case and then sealed, followed by injecting the inventive electrolytic solution thereinto to prepare a lithium ion battery. Alternatively, a lithium ion polymer battery may be prepared by way of forming an electrode stack in a bicell type, putting the stack into a battery case, pouring the inventive electrolytic solution thereinto and then sealing the case.

The following Example and Comparative Examples are given for the purpose of illustration only, and are not intended to limit the scope of the invention.

### EXAMPLE 1

88 g of LiCoO₂, 6.8 g of carbon black, 5.2 g of polyvinylidene fluoride and 52.5 g of N-methylpyrrolidone were mixed to form a cathode composition. The cathode composition was coated on an aluminum foil and dried to prepare a cathode sheet.

93.76 g of graphite, 6.24 g of polyvinylidene fluoride and 57.5 g of N-methylpyrrolidone were mixed to form an anode composition. The anode composition was coated on a copper foil and dried to prepare an anode sheet.

A polyethylene separator sheet was located between the cathode and the anode sheets to form an electrode stack. The electrode stack was wound in a jellyroll manner, placed into an aluminum can and then sealed by laser welding.

0.2 g of carbon disulfide was dissolved into 100 g of 1M LiPF₆ in a 1:1:1 volume mixture of ethylene carbonate, dimethyl carbonate and diethyl carbonate(EC/DMC/DEC) to form an electrolytic solution. The electrolytic solution was injected into the sealed can through an inlet and then ball-welded to obtain a lithium ion battery.

### EXAMPLE 2

The procedure of Example 1 was repeated except that the amount of carbon disulfide was used in an amount of 0.4 g, to obtain a lithium ion battery.

### Comparative Examples 1 and 2

The procedure of Example 1 was repeated except that the amount of carbon disulfide was used in the respective amounts of 0 g and 0.7 g, to obtain these comparative lithium ion batteries.

### Battery Performance Characteristics

The retention capacity and recovery capacity of each of the lithium ion batteries obtained in Examples and Comparative Examples are shown in Table 1. Each freshly-made battery was charged, stored for 30 days at room temperature, and its capacity on the first discharge was measured (retention capacity), while its capacity measured on the last discharge in a discharge/charge/discharge cycle was designated as recovery capacity.

TABLE 1

| | The amount of | Rentention | Recovery |
|---|---|---|---|
| | disulfide | capacity | capacity |
| | (g) | (mAh) | (mAh) |
| Example 1 | 0.2 | 588.9 | 648.9 |
| Example 2 | 0.4 | 579.8 | 638.5 |
| Comparative Example 1 | 0 | 567.1 | 624.3 |
| Comparative Example 2 | 0.7 | 570.1 | 634.6 |

As shown in Table 1, the batteries obtained in Examples 1 and 2 exhibit higher retention and recovery capacities than the batteries obtained in Comparative Examples 1 and 2. The above results suggest that the capacity of the battery exhibits a maximum value when the amount of carbon disulfide is in the range from 0.05 to 0.3% based on the amount of the electrolyte.

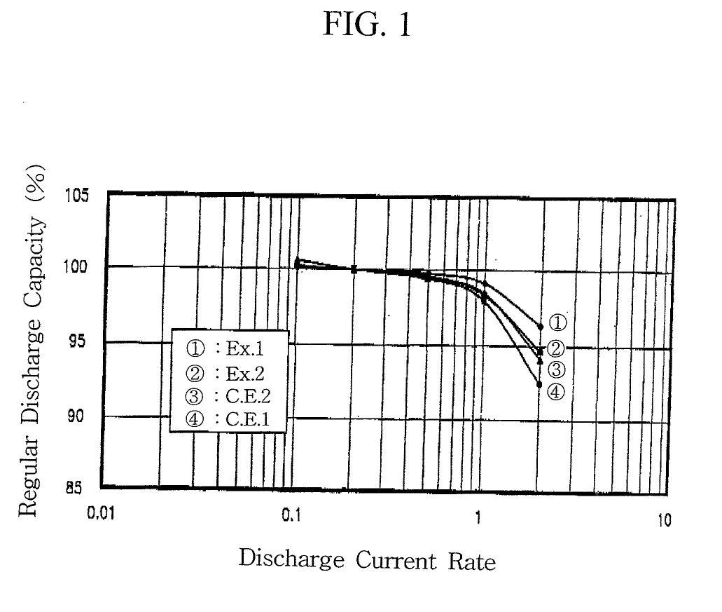

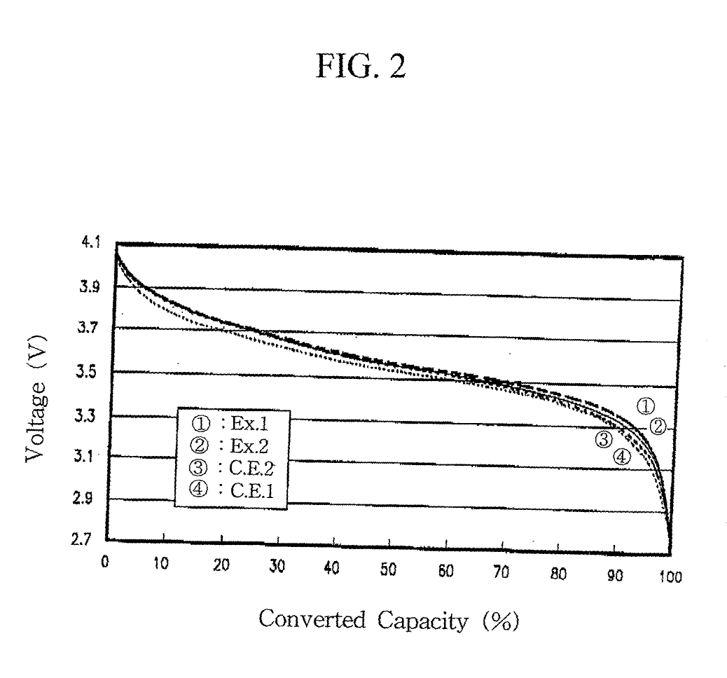

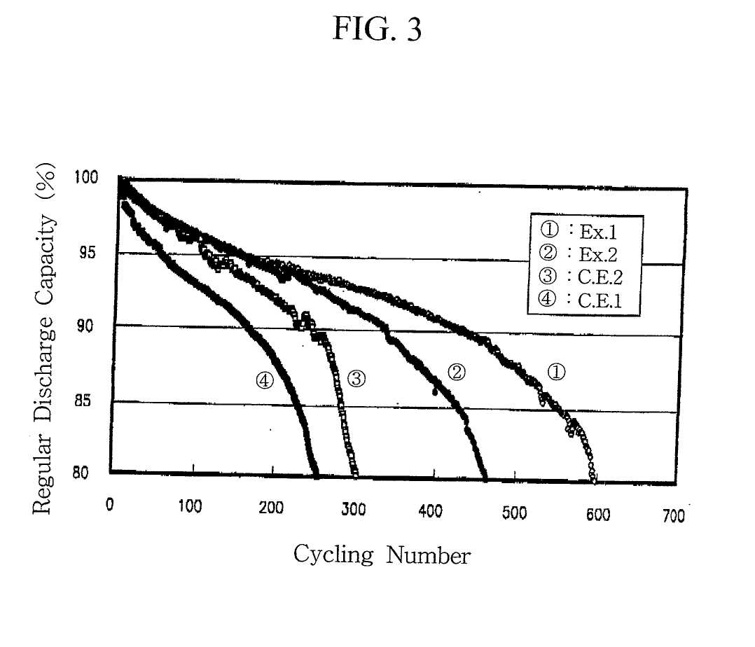

The variations of the regular discharge capacity(%) with respect to the discharge rate(C), the changes in the voltage(V) at 2C(1300 mA) discharge rate and the variations of the regular discharge capacity(%) with respect to the cycling number were measured for the lithium ion batteries obtained in Examples and Comparative Examples, and the results are shown in FIGS. 1, 2 and 3, respectively.

The batteries obtained in Examples 1 and 2 exhibit much improved properties in terms of rate, mean voltage and cycling life, as compared with the batteries obtained in Comparative Examples 1 and 2. Therefore, the inventive electrolyte composition may be advantageously used in preparing an improved lithium battery.

While the embodiments of the subject invention have been described and illustrated, it is obvious that various changes and modifications can be made therein without departing from the spirit of the present invention which should be limited only by the scope of the appended claims.

What is claimed is:

1. A liquid electrolyte composition comprising a sulfide of a IV-group element, an organic solvent and a lithium salt.

2. The composition of claim 1, wherein the sulfide is carbon disulfide.

3. The composition of claim 1, wherein the amount of the sulfide is in the range from 0.01 to 0.4% by weight based on the total weight of the composition.

4. The composition of claim 1, wherein the lithium salt is selected from the group consisting of LiClO₄, LiBF₄, LiPF₆, LiCF₃SO₃ and LiN(CF₃SO₂)₂.

5. The composition of claim 1, wherein the concentration of the lithium salt is in the range from 0.5 to 2.0M.

6. The composition of claim 1, wherein the organic solvent is selected from the group consisting of propylene carbonate, ethylene carbonate, diethyl carbonate, dimethyl carbonate, ethylmethyl carbonate, dipropyl carbonate, dimethyl sulfoxide, acetonitrile, dimethoxyethane, diethoxyethane, vinylene carbonate, gamma-butyrolactone, ethylene sulfite, propylene sulfite and tetrahydrofuran.

7. A lithium battery comprising a cathode, an anode, a separator interposed between the cathode and the anode, and the electrolyte composition of any one claim of claims 1 to 6.
